(19) United States
(12) Patent Application Publication
(10) Pub. No.: US 2014/0087648 A1
(43) Pub. Date: Mar. 27, 2014

(54) VEHICLE AIR CONDITIONING APPARATUS

(71) Applicant: KEIHIN CORPORATION, Tokyo (JP)

(72) Inventor: Masakazu Tanigawa, Shioya-gun (JP)

(73) Assignee: KEIHIN CORPORATION, Tokyo (JP)

(21) Appl. No.: 14/032,779

(22) Filed: Sep. 20, 2013

(30) Foreign Application Priority Data
Sep. 21, 2012 (JP) 2012-208945

(51) Int. Cl. B60H 1/00

(52) U.S. Cl. CPC B60H 1/00035
USPC 454/160

(57) ABSTRACT

A vehicle air conditioning apparatus includes a housing having an air flow path therein. An air guide member is provided within a mixing zone where a first air flow flowing in from a first opening provided on the air flow path within the housing and a second air flow flowing in from a second opening are mixed, and guides the first air flow and the second air flow. A slide damper adjusts an opening degree of the first opening. The air guide member has a rectifying unit rectifying the first air flow to the mixing zone, and a deflecting unit arranged closer to the second opening than the rectifying unit and deflecting a flow direction of the first air flow from a direction of the second opening. The apparatus can suppress generation of noise at the mixing zone arranged with the air guide member including the rectifying unit.

The present application claims priority under 35 U.S.C. §119 to Japanese Patent Application No. 2012-208945 with a filing date of Sep. 21, 2012. The contents of this application are incorporated herein by reference in their entirety.

### TECHNICAL FIELD

The present disclosure relates to a vehicle air conditioning apparatus.

### DESCRIPTION OF THE RELATED ART

In general, in a vehicle air conditioning apparatus, the supplied air is cooled by an evaporator to generate a cold air, and the heating ratio of this cold air is adjusted so as to generate a conditioned air.

Specifically, the vehicle air conditioning apparatus includes a housing that constitutes an outer shape and forms an air flow path therein. There are provided within the housing two flow paths, i.e. a flow path for cold air flowing and a flow path for warm air flowing. A heater core is provided in the flow path for warm air flowing.

Further, in the vehicle air conditioning apparatus, the aforementioned heating ratio of the cold air is adjusted, by adjusting the supply amount of the cold air that is supplied to the flow path in which said heater core is provided. Further, in this vehicle air conditioning apparatus, the cold air flowing in from a cold air opening and a warm air flowing in from a warm air opening are mixed, at the mixing zone provided inside the housing.

However, the cold air opening is formed to have an opening area that is relatively narrow as compared with the volume of the mixing zone. Therefore, when the cold air having passed through the cold air opening reaches the mixing zone, the cold air is separated from the wall portion of the flow path in the mixing zone, thus forming the turbulence. As a result, a so-called wind noise (noise) is generated.

Therefore, a vehicle air conditioning apparatus as described below has been proposed (e.g., see Patent Literature 1 below). In this vehicle air conditioning apparatus, an air guide member is provided in said mixing zone, and a rectifying unit that rectifies the cold air supplied from the cold air opening is provided to this air guide member. Thus, the generation of said wind noise (noise) is prevented.

### PATENT LITERATURES

Patent Literature 1: Japanese Patent Laid-Open No. 2011-105176

### SUMMARY

the vehicle air conditioning apparatus of said Patent Literature 1, the opening degree of the cold air opening is adjusted by a slide door of a slide damper. However, depending on the opening degree of this cold air opening, the cold air passing through this cold air opening may flow along the slide door, thereby crossing over the rectifying unit and flowing into the warm air opening side of the mixing zone (the air guide member). This results in the substantially head-on collision of the cold air with the warm air supplied from the warm air opening, thus forming a vortex and generating a noise.

The present disclosure has been made in consideration of the aforementioned problem and provides a vehicle air conditioning apparatus in which the generation of noise at the mixing zone arranged with an air guide member having a rectifying unit is suppressed.

According to one aspect, a vehicle air conditioning apparatus includes a housing, an air guide member and a slide damper, the housing having an air flow path therein, the air guide member being provided within a mixing zone in which a first air flow flowing in from a first opening provided on the air flow path within the housing and a second air flow flowing in from a second opening flow in an intersecting manner, and guiding the first air flow and/or the second air flow; and the slide damper including a slide door that slides along the first opening so as to adjusting an opening degree of the first opening.

The air guide member has a rectifying unit that rectifies the first air flow flowing from the first opening to the mixing zone, and a deflecting mechanism that is arranged closer to the second opening side than the rectifying unit and deflects a flow direction of the first air flow from a direction of the second opening.

Further, it is preferable that said rectifying unit is a rectifying plate member which is arranged in parallel with a flow direction of a first air flow flowing in from said first opening and extends in a width direction of said first opening, and that said deflecting mechanism is a deflecting plate member which extends in the same direction as said rectifying plate member.

Further, said deflecting plate member may also be arranged in parallel with said rectifying plate member.

Further, it is preferable that a length of said deflecting plate member in a flow direction of said first air flow is longer than a length of said rectifying plate member in a flow direction of said first air flow.

Further, it is preferable that said deflecting plate member is arranged obliquely with respect to said rectifying plate member, such that this deflecting plate member is closer to said rectifying plate member as going farther toward a downstream side of a flow direction of said first air flow.

According to one aspect, since the air guide member has a rectifying unit that rectifies a first air flow flowing from a first opening to the mixing zone, and a deflecting mechanism that is arranged closer to a second opening side (that is, the side in the direction in which said slide door moves in order to open said first opening) than the rectifying unit and deflects the flow direction of said first air flow from the direction of the second opening, even if the first air flow passing through the first opening crosses over the rectifying unit and flows into the second opening side of the mixing zone (the air guide member), the flow direction of this first air flow can be deflected from the second opening by the deflecting mechanism. Therefore, it is possible to prevent the collision in a head-on state of the first air flow with the second air flow flowing in from the second opening, thus suppressing the noise generation due to such collision.

### BRIEF DESCRIPTION OF THE DRAWINGS

FIG. 1 is a sectional view showing a schematic configuration of the first embodiment of a vehicle air conditioning apparatus.

FIG. 2(a) is a perspective view of an air guide member when it is viewed from a cold air opening side, and

FIG. 2(b) is a side view of the air guide member.

FIG. 3(a) is a side view of an air guide member according to the second embodiment,

FIG. 3(b) is a side view of an air guide member according to the third embodiment, and

FIG. 3(c) is a side view of an air guide member according to another embodiment.

FIG. 4 is a comparison chart of the frequency-noise characteristic of the apparatus of the present embodiment and the conventional apparatus, which shows a graph of the measurement result of noise of each frequency.

### DESCRIPTION OF THE EMBODIMENTS

An embodiment of a vehicle air conditioning apparatus will be described hereinafter with reference to the accompanying drawings. In the following drawings, the scale of each part is suitably changed, so as to make the size of each part recognizable.

### First Embodiment

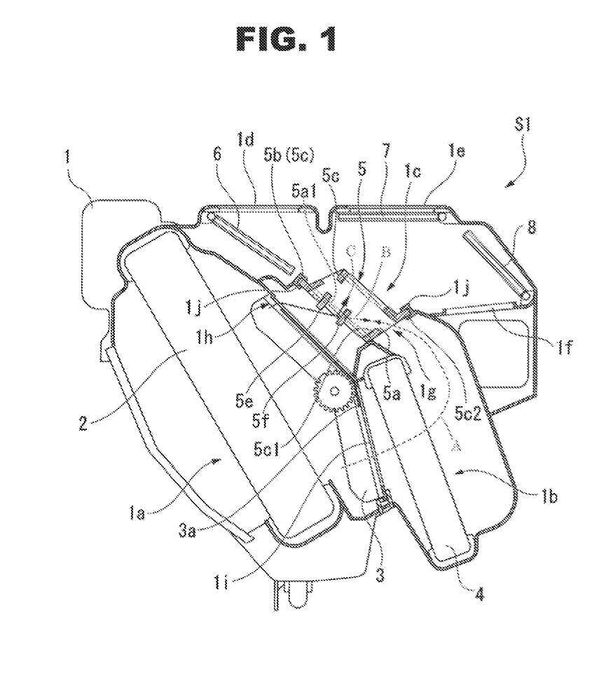

FIG. 1 is a sectional view showing a schematic configuration of a vehicle air conditioning apparatus Si (HVAC: Heating Ventilation AirConditioning)

As shown in this figure, the vehicle air conditioning apparatus S1 of the present embodiment includes: a housing 1; an evaporator 2; a slide damper apparatus 3; a heater core 4; an air guide member 5; a defroster outlet door 6; a face outlet door 7; and a foot outlet door 8.

The housing 1 constitutes an outer shape of the vehicle air conditioning apparatus S1 of the present embodiment. The housing 1 has therein: a cooling flow path 1a provided with an evaporator 2; a heating flow path 1b provided with a heater core 4 that is arranged on the position closer to the rear side of the vehicle than said evaporator 2; and a mixing portion (mixing zone) 1c where a cold air and a warm air is mixed to form a conditioned air. Further, in the cooling flow path la, there is formed an intake port (not shown) for taking in an air flow blown from a ventilator (not shown) such as a blower.

In the housing 1, there are formed a plurality of outlets being exposed to the outside and communicating with the mixing portion 1c, i.e. the defroster outlet 1d, the face outlet 1e and the foot outlet 1f. The defroster outlet 1d is an opening for supplying a conditioned air to a vehicle window. The face outlet 1e is an opening for blowing out a conditioned air to a side window while supplying a conditioned air to the face of a passenger. The foot outlet 1f is an opening for supplying a conditioned air to the feet of a passenger.

In addition, inside the housing 1, there are provided with a warm air opening 1g, a cold air opening 1h and a heating opening 1i. Said warm air opening 1g supplies a warm air to the mixing portion 1c from the heating flow path 1b provided with the heater core 4; said cold air opening 1h supplies a cold air to the mixing portion 1c from the cooling flow path 1a provided with the evaporator 2; and said heating opening 1i supplies a cold air from the cooling flow path 1a to the heating flow path 1b. With this configuration, the warm air opening (the second opening) 1g can cause a warm air as a second air flow to flow from the heating flow path 1b into the mixing portion 1c, and the cold air opening (the first opening) 1h can cause a cold air as a first air flow to flow from the cooling flow path 1a into the mixing portion 1c.

The evaporator 2 is part of a refrigeration cycle system mounted on the vehicle, and is arranged inside the cooling flow path 1a. This evaporator 2 cools the air supplied to the interior of the cooling flow path la by the ventilator (not shown), and thus a cold air is generated.

The slide damper apparatus 3 is arranged on the downstream side of the evaporator 2, and adjusts the supply amount of the cold air generated by the evaporator 2 to the heating flow path 1b. More specifically, the slide damper apparatus 3 includes a slide door 3a that is slidable between the cold air opening (the first opening) 1h and the heating opening 1i. By adjusting the opening ratio of the cold air opening 1h and the heating opening 1i by this slide door 3a, the supply amount of the cold air supplied to the heating flow path 1b is adjusted. As a result, the mixing ratio of cold air and warm air at the mixing portion 1c is adjusted, and the temperature of the conditioned air is adjusted.

The heater core 4 is arranged inside the heating flow path 1b, and heats the cold air supplied via the heating opening 1i to generate heated air, i.e. warm air.

The air guide member 5 is provided in the mixing zone of warm air and cold air inside the housing 1, i.e. in the mixing portion 1c, and guides the warm air flowing in from said warm air opening 1g and the cold air flowing in from said cold air opening 1h, respectively.

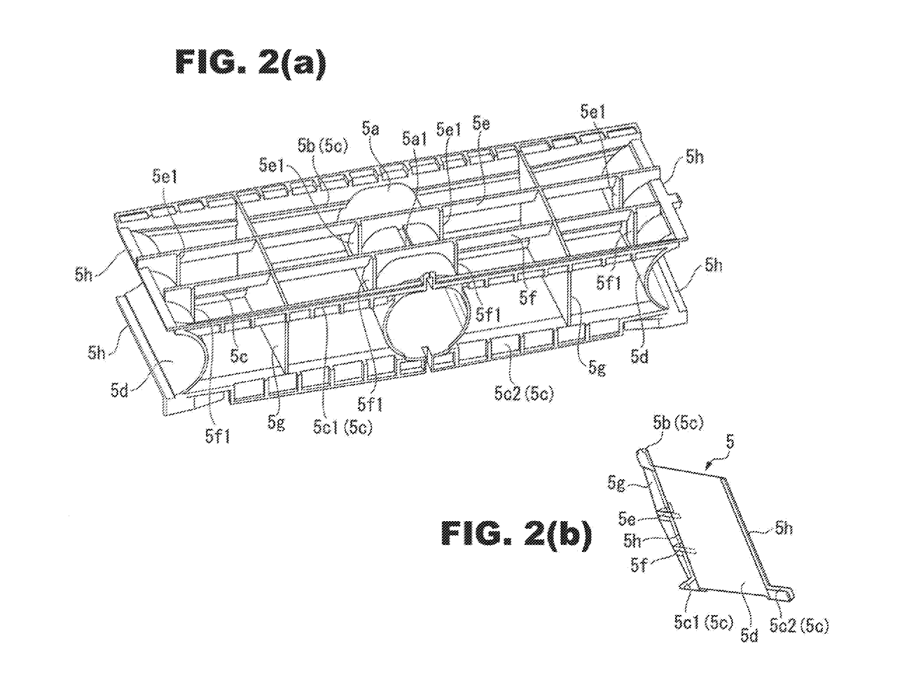

FIG. 2(a) is a perspective view of the air guide member 5 when it is viewed from the cold air opening 1h side. As shown in this figure, the air guide member 5 is a substantially rectangular parallelepiped shape as a whole, and is composed of a warm air guide tube 5a, an adjustment plate member 5b, a support plate member 5c, a sidewall part 5d, a rectifying plate member (rectifying unit) 5e, a deflecting plate member (deflecting unit) 5f and a support plate 5g.

The warm air guide tube 5a is a substantially cylindrical shape, and is arranged and formed at the central portion of the air guide member 5 in the width direction, that is, the central portion in the direction orthogonal to the plane of FIG. 1. This warm air guide tube 5a is a straight tubular part, such that part of the warm air supplied from the warm air opening 1g to the mixing portion 1c is not mixed with the cold air at the mixing portion 1c, but is guided to the defroster outlet 1d. This warm air guide tube 5a is configured such that the opening at one end is connected with the warm air opening 1g, and the opening at the other end faces to the defroster outlet 1d.

Further, as shown in FIG. 2(a), on the cold air opening 1h side of the warm air guide tube 5a, a cold air inlet 5a1 is formed between the rectifying plate member 5e and the deflecting plate member 5f. This cold air inlet 5a1 is used for introducing part of the cold air supplied from the cold air opening 1h to the mixing part 1c, into the warm air guide tube 5a.

The adjustment plate member 5b is used for deflecting the flow direction of the cold air flowing from the cold air opening 1h into the mixing portion 1c, toward the warm air opening 1g side. A portion of this adjustment plate member 5b, on the side opposite to the cold air opening 1h is inclined toward the warm air opening 1g side.

Further, the adjustment plate member 5b also functions as a support plate member 5c which functions as a frame by which the air guide member 5 supports the shape of its own. That is, in the vehicle air conditioning apparatus S1 of the present embodiment, the adjustment plate member 5b is integrated with one support plate member 5c.

As described above, the support plate member 5c functions as a frame by which the air guide member supports the shape of its own, and the support plate member 5c includes a portion integrated with the adjustment plate member 5b, and is connected to the four corners of the warm air guide tube 5a, respectively. In addition, the support plate member 5c and the adjustment plate member 5b are arranged in parallel with each other, such that these plate members become four longitudinal sides of the air guide member 5 which is a rectangular parallelepiped shape. In addition, the support plate member 5c integrated with the adjustment plate member 5b is arranged on the upper end side of the cold air opening 1h. One support plate member 5c (a first support plate member 5c1) is arranged on the lower end side of the cold air opening 1h, and another support plate member 5c (a second support plate member 5c2) is arranged on the side of the warm air opening 1g which is farther from the cold air opening 1h.

The sidewall part 5d is arranged and formed at the portions on both sides of the air guide member 5 in the width direction, the width direction is orthogonal to the plane of FIG. 1. As shown in FIG. 2(a), this sidewall part 5d has an engaging portion 5h at the straight portions on both sides thereof. The engaging portion 5h fixes the air guide member 5 to the housing 1 by being engaged with the housing 1.

Also as shown in FIG. 1, on the upper end side of the cold air opening 1h and on the side of the warm air opening 1g that is farther from the cold air opening 1h, each fitting groove 1j extending in the direction perpendicular to the plane of FIG. 1 is formed. And, by fitting the adjustment plate member 5b and the support plate member 5c (5c2) into these fitting grooves 1j, the air guide member 5 is positioned.

The rectifying plate member 5e is horizontally arranged on the cold air opening 1h side, and suppress the formation of vortex by rectifying the cold air that is supplied from the cold air opening 1h and flows into the mixing portion 1c, thus suppressing the generation of wind noise. That is, the vehicle air conditioning apparatus S1 of the present embodiment includes a rectifying plate member 5e that is provided at the mixing portion 1c and rectifies the cold air flowing from the cold air opening 1h to the mixing portion (mixing zone) 1c.

This rectifying plate member 5e is formed as part of the air guide member 5, and the side surface thereof is supported by a plurality of support ribs 5e1. These support ribs 5e1 are also formed as part of the air guide member 5, similar to the rectifying plate member 5e.

Also as shown in FIG. 1, the rectifying plate member 5e is arranged in parallel with the blowing direction of the cold air from the cold air opening 1h. When the opening ratio in which the slide door 3a opens the cold air opening 1h is 50% (i.e., when the slide door 3a is located on the intermediate position where the cold air opening 1h and the heating opening 1i are opened equivalently), for example, the rectifying plate member 5e is arranged on the extension line extending from the end of the slide door 3a in the direction of cold air flowing. Moreover, as shown in a side view of the air guide member 5, i.e. FIG. 2(b), the rectifying plate member 5e is formed to extend more closely to the cold air opening 1h side than the sidewall part 5d.

As shown in FIG. 1 and FIG. 2(a), the deflecting plate member 5f is disposed more closely to the warm air opening 1g side than the rectifying plate member 5e and is configured to extend in the same direction as the rectifying plate member 5e, and is arranged in parallel with the rectifying plate member 5e. Further, as shown in FIG. 2(b), this deflecting plate member 5f is formed such that the length in the flowing direction of the cold air flowing in from the cold air opening 1h is the same as the length of the rectifying plate member 5e in the same direction. According to such a configuration, the deflecting plate member 5f deflects the flowing direction of the cold air (a first air flow) passing through the cold air opening 1h and flowing to the air guide member 5 side, toward the rectifying plate member 5e side.

That is, as shown in FIG. 1, for example, in the case that the slide door 3a closes the most part of the cold air opening 1h such that the side opposite to the heating opening 1i only opens slightly, as indicated by the solid line arrow in FIG. 1, part of the cold air passing through the cold air opening 1h flows through between the slide door 3a and the rectifying plate member 5e along the slide door 3a, and crosses over this rectifying plate member 5e, thus flowing in the warm air opening 1g side of the mixing portion 1c (the air guide member 5).

At this time, in a prior art in which the deflecting plate member 5f is not provided, the cold air advances straightly toward the warm air opening 1g side as shown by a two-dot chain line arrow B in FIG. 1, and collides substantially head-on with the warm air from the warm air opening 1g as shown by a broken line arrow A in FIG. 1. As a result, the vortex is formed due to this collision of cold air with warm air, thus generating the noise.

In this regard, in the present embodiment, since the deflecting plate member 5f is arranged closer to the warm air opening 1g side than the rectifying plate member 5e, even if part of the cold air passing through the cold air opening 1h crosses over the rectifying plate member 5e and flows toward the warm air opening 1g side of the mixing portion 1c (the air guide member 5), due to the action of the deflecting plate member 5f, the flowing direction of the cold air can be deflected in a manner of leaving the warm air opening 1g side as shown by the solid line arrow C in FIG. 1. Therefore, it is possible to prevent the head-on collision of the cold air with the warm air flowing in from the warm air opening 1g, and to cause the cold air and the warm air to intersect at an angle of a certain degree. Therefore, it is possible to suppress the noise generated due to the formation of vortex.

In addition, this deflecting plate member 5f is also formed as part of the air guide member 5, and as shown in FIG. 2(a), the back side of this deflecting plate member 5f is supported by a plurality of support ribs 5f1. These support ribs 5f1 also form part of the air guide member 5, similar to the deflecting plate member 5f

The support plate 5g is arranged between the warm air guide tube 5a and the sidewall part 5d, and is held by the support plate member 5c. The rectifying plate member 5e and the deflecting plate member 5f are reinforced by being supported by the support plate 5g. In addition, the support plate 5g limits the flowing of the warm air from the warm air opening 1g while limiting the flowing of the cold air from the cold air opening 1h, and rectifies these cold air and warm air. By being rectified by the support plate 5g in such way, the mixing of cold air and warm air is facilitated, and a mixed flow (a conditioned air) is formed and is caused to flow toward the defroster outlet 1d, the face outlet 1e and the foot outlet 1f.

Returning to FIG. 1, the defroster outlet door 6 is arranged on inner side of the defroster outlet 1d, is a damper for opening and closing the defroster outlet 1d and is rotatable within the housing 1.

The face outlet door 7 is arranged on inner side of the face outlet 1e, is a damper for opening and closing the face outlet 1e, and is rotatable within the housing 1.

The foot outlet door 8 is arranged on inner side of the foot outlet 1f, is a damper for opening and closing the foot outlet 1f, and is configured to be rotatable within the housing 1.

Further, the slide damper apparatus 3, the defroster outlet door 6, the face outlet door 7 and the foot outlet door 8 described above are caused to slide or open and close by a motor which is not shown in the drawings.

According to the vehicle air conditioning apparatus S1 of the present embodiment having the above configuration, when the cold air opening 1h and the heating opening 1i both are opened by the slide damper apparatus 3, the air supplied to the cooling flow path 1a is cooled by the evaporator 2 and thus forms a cold air, part of which is supplied to the heating flow path 1b.

Further, the warm air generated by being heated in the heating flow path 1b by the heater core 4, flows from the warm air opening 1g into the mixing portion 1c, and the cold air that is not supplied to the heating flow path 1b flows from the cold air opening 1h into the mixing portion 1c.

The cold air and the warm air supplied to the mixing portion 1c are guided to the air guide member 5 to be mixed, and are supplied to any one of the defroster outlet 1d, the face outlet le and the foot outlet 1f, and being supplied into the vehicle through opened one of the outlets.

At this time, in the vehicle air conditioning apparatus S1 of the present embodiment, since the air guide member 5 has the rectifying plate member 5e that rectifies the cold air flowing from the cold air opening 1h into the mixing portion 1c, and the deflecting plate member 5f that is arranged closer to the warm air opening 1g side than this rectifying plate member 5e and causes the flowing direction of the cold air to be deflected in a manner of leaving the warm air opening 1g side, even if the cold air passing through the cold air opening 1h crosses over the rectifying plate member 5e to flow into the warm air opening 1g side of the mixing portion 1c (air guide member 5), the flowing direction of this cold air can be deflected by the deflecting plate member 5f in a manner of leaving the warm air opening 1g side. Therefore, it is possible to prevent the head-on collision of the cold air with the warm air flowing in from the warm air opening 1g, thereby suppressing the noise generated due to this collision.

Further, in the present embodiment, the rectifying plate member 5e and the deflecting plate member 5f are formed in the mixing portion 1c, as part of the air guide member 5 for guiding warm air and cold air. Therefore, by shaping the air guide member 5 using injection molding, and providing this air guide member 5 in the mixing portion 1c, the rectifying plate member 5e and the deflecting plate member 5f can be formed and arranged, respectively.

Therefore, there is no need to additionally set a procedure for manufacturing or arranging the rectifying plate member 5e and the deflecting plate member 5f.

Further, in the present embodiment, since the rectifying plate member 5e is arranged in parallel with the flowing direction of the cold air flowing in from the cold air opening 1h, it is possible to rectify the cold air from the cold air opening 1h without changing the blowing direction thereof Further, since the deflecting plate member 5f is configured to extend in the same direction as the rectifying plate member 5e, it is possible to cause the cold air flowing to the deflecting plate member 5f side to be deflected substantially uniformly in the longitudinal direction of this deflecting plate member 5f, in a manner of leaving the warm air opening 1g side. Therefore, it is possible to desirably prevent the head-on collision of the cold air with the warm air flowing in from the warm air opening 1g, thereby reliably suppressing the generation of noise.

Further, since the deflecting plate member 5f is arranged in parallel with the rectifying plate member 5e, it is possible to cause the flowing direction of the cold air deflected toward the rectifying plate member 5e side due to the deflecting plate member 5f, to be substantially consistent with the flowing direction of the cold air rectified by the rectifying plate member 5e. Therefore, it is possible to stabilize the flowing of the cold air flowing out from the air guide member 5.

### Second Embodiment

Next, a description will be given of a second embodiment of the vehicle air conditioning apparatus S1.

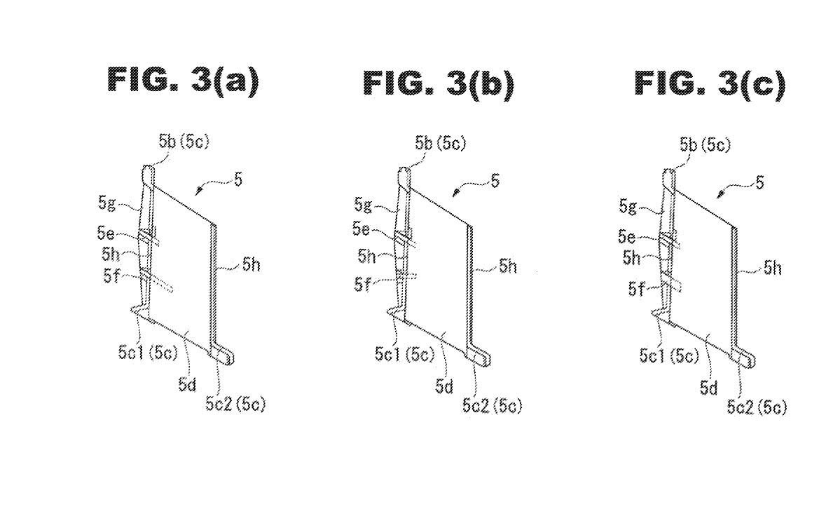

The difference between the present embodiment and the first embodiment is in the form of the deflecting plate member 5f That is, in the first embodiment, as shown in FIG. 2(b), the deflecting plate member 5f is formed such that the length thereof in the flowing direction of the cold air flowing in from the cold air opening 1h is the same as the length of the rectifying plate member 5e in the same direction. In this regard, in the present embodiment, as shown in FIG. 3(a), the deflecting plate member 5f is formed such that the length thereof in the flowing direction of the cold air flowing in from the cold air opening 1h is longer than the length of the rectifying plate member 5e in the same direction.

By forming the deflecting plate member 5f in this way, the cold air of a wider range can be deflected toward the rectifying plate member 5e side. Therefore, it is possible to desirably suppress the generation of noise.

### Third Embodiment

Next, a description will be given of a third embodiment of the vehicle air conditioning apparatus S1.

The difference between the present embodiment and the first embodiment is also in the form of the deflecting plate member 5f. That is, in the present embodiment, as shown in FIG. 3(b), instead of providing the deflecting plate member 5f in parallel with the rectifying plate member 5e, the deflecting plate member 5f is arranged obliquely with respect to said rectifying plate member 5e, such that the deflecting plate member 5f is closer to the rectifying plate member 5e as going farther toward the downstream side of the flowing direction of cold air.

Since the deflecting plate member 5f is formed in this way, the cold air can be deflected more significantly to leave the warm air opening 1g side.

Therefore, it is possible to desirably suppress the generation of noise.

### Other Embodiments

The form of the deflecting plate member 5f is not limited to that of the first embodiment to the third embodiment, but may adopt other various forms. For example, as shown in FIG. 3(c), the thickness of the deflecting plate member 5f can also be set to be greater than the thickness of the rectifying plate member 5e. By forming the deflecting plate member 5f in this way, the cold air passing through this deflecting plate member 5f is dispersed vertically into two parts, thus the flow momentum thereof can be weakened. Therefore, it is possible to weaken the collision force of cold air and warm air, thus desirably suppressing the generation of noise.

### Experimental Example

The vehicle air conditioning apparatus of Patent Literature 1 (conventional) including the rectifying plate member 5e and the vehicle air conditioning apparatus S1 of the first embodiment including the rectifying plate member 5e and the deflecting plate member 5f are operated under the same conditions. And, the noise for each frequency is measured.

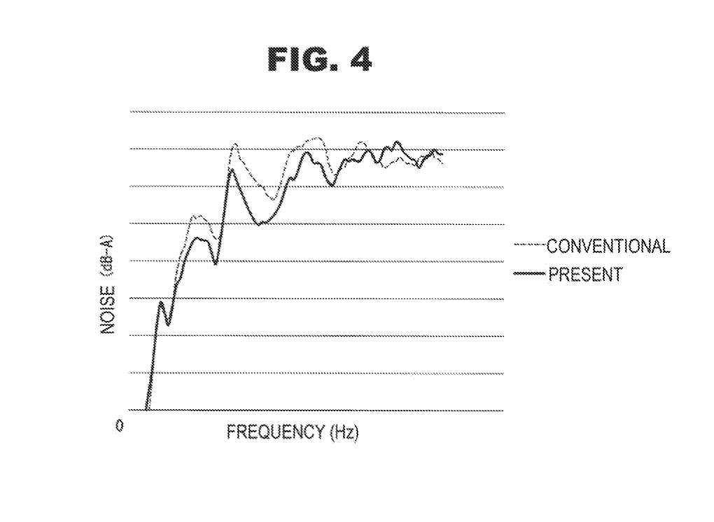

The measurement results are shown in FIG. 4.

As shown in FIG. 4, in comparison with the conventional device indicated by a broken line, the apparatus of the embodiment indicated by a solid line is lower in noise. Thus, it is confirmed that the vehicle air conditioning apparatus S1 of the first embodiment that is attached with the deflecting plate member 5f can suppress the generation of noise.

In the above, while the embodiments have been described, the present invention is not limited to the described embodiments, and various modifications are possible within the scope without departing from the spirit of the present invention.

For example, in the described embodiments, a description has been given of the configuration in which the first air flow is a cold air and the second air flow is a warm air. However, the present invention is not limited to this, and a configuration in which the first air flow is a warm air and the second air flow is a cold air, may also be adopted. Moreover, two air flows that are the same in temperature but are guided by different air supply paths, may also be set as the first air flow and the second air flow.

We claim:

1. A vehicle air conditioning apparatus comprising:
a housing;
an air guide member; and
a slide damper,
wherein the housing comprises an air flow path and a mixing zone, the air flow path including a first air flow path with a first opening and a second air flow path with a second opening, the mixing zone is disposed on a downstream side of the first air flow path and the second air flow path such that a first air flow from the first opening and a second air flow from the second opening flow in the mixing zone and intersect with each other in the mixing zone,
wherein the air guide member is provided in the mixing zone to guide the first air flow, or the second air flow or both of the first air flow and the second air flow,
wherein the slide damper includes a slide door sliding along the first opening so as to adjust an opening degree of the first opening, and wherein the air guide member includes a rectifying unit rectifying the first air flow flowing from the first opening to the mixing zone, and a deflecting unit disposed closer to the second opening than the rectifying unit and deflecting a flow direction of the first air flow directed toward the second opening.

2. The vehicle air conditioning apparatus according to claim 1, wherein the rectifying unit is a rectifying plate member provided in parallel with a flow direction of the first air flow flowing in from the first opening, and extending in a width direction of the first opening, and the deflecting unit is a deflecting plate member extending in the same direction as the rectifying plate member.

3. The vehicle air conditioning apparatus according to claim 2, wherein the deflecting plate member is provided in parallel with the rectifying plate member.

4. The vehicle air conditioning apparatus according to claim 2, wherein a length of the deflecting plate member in a flow direction of the first air flow is longer than a length of the rectifying plate member in a flow direction of the first air flow.

5. The vehicle air conditioning apparatus according to claim 2, wherein the deflecting plate member is provided obliquely with respect to the rectifying plate member, such that a distance between the deflecting plate member and the rectifying plate member decreases along a flow direction of the first air flow.
